(19) United States
(12) Patent Application Publication
(10) Pub. No.: US 2025/0220729 A1
(43) Pub. Date: Jul. 3, 2025

(54) PERFORMING OPERATIONS WITH MULTIPLE CARRIERS IN A WIRELESS COMMUNICATIONS SYSTEM

(71) Applicant: Lenovo (United States) Inc., Morrisville, NC (US)

(72) Inventors: Karthikeyan Ganesan, Nauheim (DE); Ravi Kuchibhotla, Chicago, IL (US); Ali Ramadan Ali, Kraiburg am Inn (DE)

(21) Appl. No.: 19/087,305

(22) Filed: Mar. 21, 2025

(51) Int. Cl. H04W 74/0833; H04L 5/00; H04L 5/14; H04W 68/02

(52) U.S. Cl. CPC H04W 74/0833; H04L 5/0044; H04L 5/14; H04W 68/02

(57) ABSTRACT

Various aspects of the present disclosure relate to methods, apparatuses, and devices for wireless communication. A user equipment (UE) may be configured to, capable of, or operable to receive, from a base station, a configuration for selecting one or more of an anchor carrier or a non-anchor carrier, wherein one or more of the anchor carrier or the non-anchor carrier is selected for at least one or more of a paging message, a required minimum system information (RMSI), a random access procedure, or a random access message 4 (msg4), and wherein the configuration comprises a first mapping between a set of carriers and a set of priorities associated with the set of carriers. The UE may be configured to, capable of, or operable to select the one or more of the anchor carrier or the non-anchor carrier.

### TECHNICAL FIELD

The present disclosure relates to wireless communications, and more specifically to performing operations with multiple carriers in a wireless communications system.

### BACKGROUND

A wireless communications system may include one or multiple network communication devices, which may be known as a network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-Advanced (5G-A), sixth generation (6G), etc.).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

Various aspects of the present disclosure relate to wireless communications, including improved network entities, processors, and methods for performing operations with multiple carriers in a wireless communications system.

A UE for wireless communication is described. The UE may be configured to, capable of, or operable to receive, from a base station, a configuration for selecting one or more of an anchor carrier or a non-anchor carrier, wherein one or more of the anchor carrier or the non-anchor carrier is selected for at least one or more of a paging message, a required minimum system information (RMSI), a random access procedure, or a random access message 4 (msg4), and wherein the configuration comprises a first mapping between a set of carriers and a set of priorities associated with the set of carriers. The UE may be configured to, capable of, or operable to select the one or more of the anchor carrier or the non-anchor carrier.

A processor for wireless communication is described. The processor may be configured to, capable of, or operable to receive, from a base station, a configuration for selecting one or more of an anchor carrier or a non-anchor carrier, wherein one or more of the anchor carrier or the non- anchor carrier is selected for at least one or more of a paging message, a RMSI, a random access procedure, or a msg4, and wherein the configuration comprises a first mapping between a set of carriers and a set of priorities associated with the set of carriers. The processor may be configured to, capable of, or operable to select the one or more of the anchor carrier or the non-anchor carrier.

A method performed or performable by a UE for wireless communication is described. The method may include receiving, from a base station, a configuration for selecting one or more of an anchor carrier or a non-anchor carrier, wherein one or more of the anchor carrier or the non-anchor carrier is selected for at least one or more of a paging message, a RMSI, a random access procedure, or a msg4, and wherein the configuration comprises a first mapping between a set of carriers and a set of priorities associated with the set of carriers. The method may include selecting the one or more of the anchor carrier or the non-anchor carrier.

A base station for wireless communication is described. The base station may be configured to, capable of, or operable to transmit, to a UE, a configuration for selecting one or more of an anchor carrier or a non-anchor carrier, wherein one or more of the anchor carrier or the non-anchor carrier is selected for at least one or more of a paging message, a RMSI, a random access procedure, or a msg4, and wherein the configuration comprises a first mapping between a set of carriers and a set of priorities associated with the set of carriers.

A processor for wireless communication is described. The processor may be configured to, capable of, or operable to transmit, to a UE, a configuration for selecting one or more of an anchor carrier or a non-anchor carrier, wherein one or more of the anchor carrier or the non-anchor carrier is selected for at least one or more of a paging message, a RMSI, a random access procedure, or a msg4, and wherein the configuration comprises a first mapping between a set of carriers and a set of priorities associated with the set of carriers.

A method performed or performable by a base station for wireless communication is described. The method may include transmitting, to a UE, a configuration for selecting one or more of an anchor carrier or a non-anchor carrier, wherein one or more of the anchor carrier or the non-anchor carrier is selected for at least one or more of a paging message, a RMSI, a random access procedure, or a msg4, and wherein the configuration comprises a first mapping between a set of carriers and a set of priorities associated with the set of carriers.

### BRIEF DESCRIPTION OF THE DRAWINGS

FIG. 1 illustrates an example of a wireless communications system in accordance with aspects of the present disclosure.

FIG. 2 illustrates an example of a transmission scheme for RMSI on a serving carrier in accordance with aspects of the present disclosure.

FIGS. 3 through 5 illustrate examples of wireless communication on multiple carriers in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of a NE in accordance with aspects of the present disclosure.

FIG. 9 illustrates a flowchart of a method performed by a UE in accordance with aspects of the present disclosure.

FIG. 10 illustrates a flowchart of a method performed by a base station in accordance with aspects of the present disclosure.

### DETAILED DESCRIPTION

Some wireless communication systems, including one or more UEs, base stations, or other network entities may perform multicarrier operations. In some cases, these operations may be inefficient due to increased signaling overhead and power consumption. By way of example, some wireless communication systems may transmit and/or receive data having a high ON-time requirements, resulting in greater resource usage (e.g., system bandwidth) and placing higher demands on device power and processing capabilities.

Various aspects of the present disclosure relate to enabling one or more UEs, base stations, network entities, or the like to support improvements to reducing an ON-time (e.g., active duration) for certain carriers. In some examples, one or more UEs, base stations, network entities, or the like may be configured to communicate with a serving carrier. Additionally, or alternatively, one or more UEs, base stations, network entities, or the like may be configured to enable the serving carrier to communicate with anchor and/or non-anchor carriers. By reducing ON-time of certain carriers, one or more UEs, base stations, network entities, or the like may experience reduced power consumption, decreased processor usage, reduce data usage, and increase overall system performance.

Aspects of the present disclosure are described in the context of a wireless communications system.

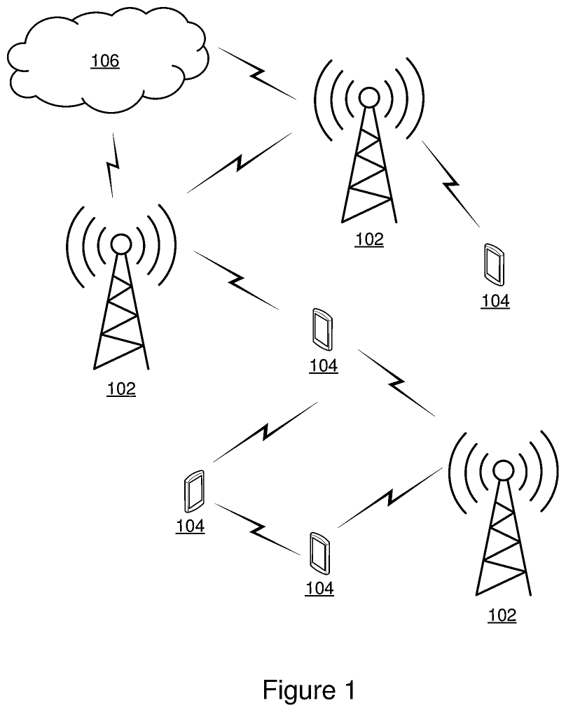

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with an NTN. In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a UE-to-UE interface (PC5 interface).

An NE 102 may support communications with the CN 106, or with another NE 102, or both. For example, an NE 102 may interface with other NE 102 or the CN 106 through one or more backhaul links (e.g., S1, N2, N3, or network interface). In some implementations, the NE 102 may communicate with each other directly. In some other implementations, the NE 102 may communicate with each other or indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N3, N6 or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHZ-7.125 GHZ), FR2 (24.25 GHZ-52.6 GHZ), FR3 (7.125 GHZ-24.25 GHZ), FR4 (52.6 GHz-114.25 GHZ), FR4a or FR4-1 (52.6 GHZ-71 GHZ), and FR5 (114.25 GHz-300 GHz). In some implementations, the NEs 102 and the UEs 104 may perform wireless communications over one or more of the operating frequency bands. In some implementations, FRI may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In 5G networks, a primary cell (PCell) may handle transmissions, including common channels and signals for initial access, paging, and random access channel (RACH) reception, while also scheduling secondary cells (SCells) that transmit data channels. In 6G networks, multi-carrier scheduling may enhance energy efficiency by transmitting initial access on one carrier while handling scheduling on another. Additionally, 6G may support wider bandwidths, such as 200 MHZ in the upper mid-band spectrum, requiring efficient wideband operations. 6G may feature a unified radio access technology (RAT) design to support diverse devices and use cases. For example, enhanced mobile broadband (eMBB) requires high data rates, while massive machine-type communications (mMTC) and internet of things (IoT)/low power wide area (LPWA) require low data rates and deep coverage. Embodiments herein may relate to initial access procedures when devices move across multiple cells or bandwidth parts (BWPs).

A serving carrier, also referred to as a camping carrier, may be an always-ON carrier providing downlink synchronization signals and a physical cell identifier. An anchor carrier may be a carrier with its own downlink reference timing, whereas a non-anchor carrier may be a carrier without its own downlink timing, instead relying on an anchor carrier for reference. A single cell may include a serving carrier, such as one operating below 1 GHz to provide coverage, in combination with capacity provided by an anchor carrier and a non-anchor carrier.

A NE 102 (e.g., a base station) may provide a UE 104 with a list of available anchor and non-anchor carriers, allowing the UE 104 to select carriers based on one or more criteria, including device type-to-carrier mapping priority, traffic type-to-carrier mapping priority, signal strength and path loss measurements, carrier frequency load conditions, and device-specific carrier frequency priorities.

During an initial access procedure, a serving carrier may direct a second device type to a different downlink carrier and/or uplink carrier based on a carrier frequency priority. The downlink carrier and/or uplink carrier may be selected based on RMSI, paging, RACH, a Msg4, and/or data transmission/reception (Tx/Rx). Meanwhile, UEs 104 of a first device type may continue receiving data on the serving carrier. An uplink carrier selection may depend on a location of a UE 104 within a downlink coverage area, a received downlink signal strength, and/or carrier frequency priority specific to the device type. For example, downlink synchronization signals may be transmitted in an upper mid-band frequency, while uplink transmissions could occur in a lower frequency band, such as 2 GHz, to ensure adequate uplink coverage. The NE 102 may offload specific device types to alternative downlink carriers during initial access, allowing them to receive system information, paging, Msg4, or other control signaling according to device-type-specific frequency priority and the UE's 104 capability to support multiple frequency bands.

The NE 104 may assist the UE in selecting downlink and/or uplink carriers for initial access. The UE 102 may choose a suitable carrier from a list of available frequencies across multiple bands, such as FR1 and FR3, based on device type, signal strength, and/or coverage requirements. one or more downlink frequencies or uplink frequencies associated with the anchor carrier or the non-anchor carrier are frequency division duplexed (FDD'ed), or wherein transmission associated with the anchor carrier or the non-anchor carrier are time division duplexed (TDD'ed). one or more downlink frequencies associated with the transmission are applicable for only downlink, or wherein one or more uplink frequencies associated with the transmission are applicable for only uplink.

RMSI for anchor and non-anchor carriers may be transmitted in the serving carrier and may include information such as a carrier identifier (ID), absolute radio frequency channel number (ARFCN) ID, or cell ID to facilitate the identification of received system information blocks. Common search space monitoring settings, reception periodicity, and resource configurations for the RMSI of anchor and non-anchor carriers may be signaled within the RMSI of the serving carrier.

The transmission of RMSI may occur through different methods. In one option, RMSI for anchor and non-anchor carriers may be transmitted at different intervals compared to that of the serving carrier. For example, while the RMSI of the serving carrier may be transmitted with a 20 ms periodicity, the RMSI for anchor and non-anchor carriers may be transmitted at a longer periodicity. The serving carrier's RMSI may also indicate the periodicity of the RMSI transmission for anchor and non-anchor carriers. Another option may include transmitting RMSI on an on-demand basis, wherein the serving carrier may contain an uplink wake-up signal (UL-WUS) configuration to request on-demand RMSI. The UL-WUS configuration may be separately provided to request RMSI for one or more anchor or non-anchor carriers. In a further alternative, only essential parts of the RMSI for anchor and non-anchor carriers may be transmitted in the serving carrier, such as cell selection and reselection parameters, cell access information, paging monitoring configurations, frequency information of the carrier, random access configuration, Msg4 configuration, and physical downlink control channel (PDCCH) search space information necessary for monitoring the remaining RMSI in the respective anchor or non-anchor carriers.

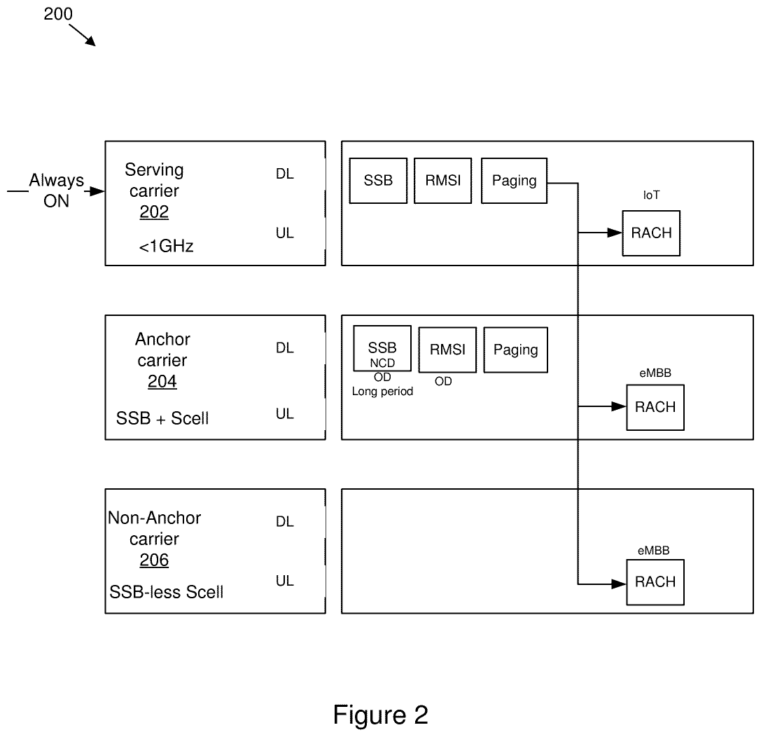

FIG. 2 illustrates an example 200 of a transmission scheme for RMSI on a serving carrier in accordance with aspects of the present disclosure. In some examples, the wireless communication on multiple carriers may implement aspects of the wireless communications system 100. For example, one or more of an NE 102 or a UE 104 may support wireless communication on one or more of a serving carrier 202 (e.g., UL and DL, SSB and RMSI), an anchor carrier 204 (e.g., UL and DL, SSB and RMSI), or a non-anchor carrier 206 (e.g., UL and DL). Additionally, one or more of the NE 102 or the UE 104 may support random access on one or more of the serving carrier 202, the anchor carrier 204, or the non-anchor carrier 206. Additionally, or alternatively, one or more of the NE 102 or the UE 104 may support paging on one or more of the serving carrier 202, the anchor carrier 204, or the non-anchor carrier 206. A paging signal in the serving carrier 202 and/or the anchor carrier 204 may trigger RACH in one or more of the serving carrier 202, the anchor carrier 204, and the non-anchor carrier 206.

Synchronization signals transmission from an anchor downlink carrier may provide a reference timing for other SSB-less carriers and uplink-only carriers. This synchronization may be configured with an on-demand operation using UL-WUS, a longer periodicity, and a non-cell-defining approach. In another implementation, an on-demand synchronization signal block (SSB) configuration for the anchor carrier may be signaled from the serving carrier, including parameters such as the frequency start location of the SSB transmission, the number of SSBs, and the UL-WUS configuration required to request on-demand SSBs. In another implementation, the periodicity of SSBs may be extended, and such periodicity configurations may be signaled from the serving carrier.

For paging reception and RACH access, the UE 102 may receive synchronization signals and RMSI in the serving or anchor carrier and may monitor for paging messages during its paging occasion in the serving carrier. The RMSI may contain a list of uplink carrier frequencies available for RACH transmissions, which the UE 102 may select based on device type and signal conditions. Upon receiving a paging message, the UE 102 may reselect one of the uplink carriers configured for its device type. In cases where the uplink carrier is uplink-only, the UE 102 may receive downlink reference timing from the synchronization signal of a corresponding serving or anchor downlink carrier. If the synchronization source is a serving carrier where the UE 102 receives the reference timing, the RACH resource allocation may be obtained from the RMSI transmitted by the downlink serving carrier. If the synchronization source for the uplink-only carrier is an anchor downlink carrier, the UE may need to synchronize with the anchor downlink carrier and receive the RACH resource configuration before transmitting RACH in the uplink-only carrier.

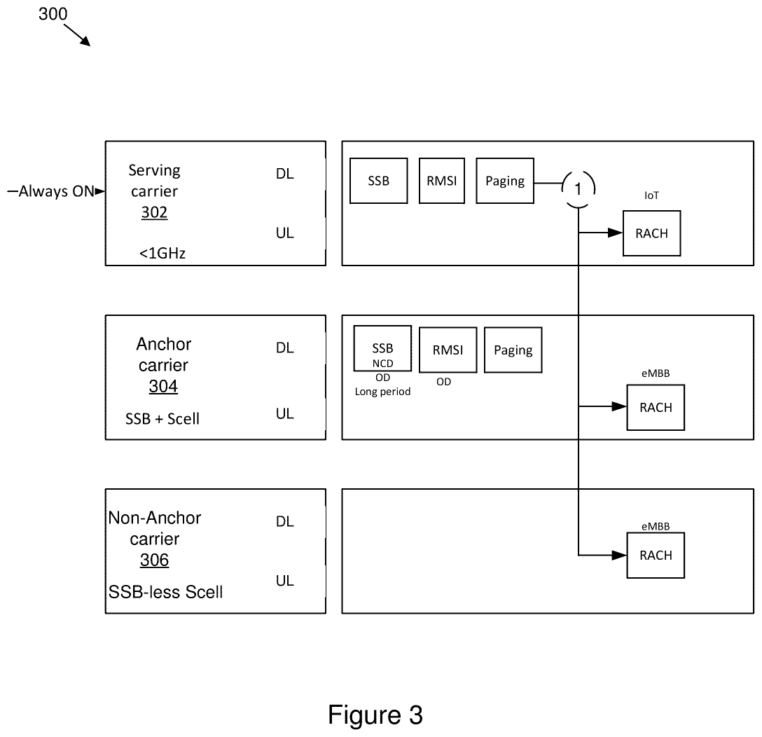

FIG. 3 illustrates an example 300 of wireless communication on multiple carriers in accordance with aspects of the present disclosure. In some examples, the wireless communication on multiple carriers may implement aspects of the wireless communications system 100. For example, one or more of an NE 102 or a UE 104 may support wireless communication on one or more of a serving carrier 302 (e.g., UL and DL, SSB and RMSI), an anchor carrier 304 (e.g., UL and DL, SSB and RMSI), or a non-anchor carrier 306 (e.g., UL and DL). Additionally, one or more of the NE 102 or the UE 104 may support random access on one or more of the serving carrier 302, the anchor carrier 304, or the non-anchor carrier 306. Additionally, or alternatively, one or more of the NE 102 or the UE 104 may support paging on one or more of the serving carrier 302, the anchor carrier 304, or the non-anchor carrier 306. A paging signal in the serving carrier 302 and/or the anchor carrier 304 may trigger RACH in one or more of the serving carrier 302, the anchor carrier 304, and the non-anchor carrier 306.

The UE 102 may also receive paging messages in an anchor carrier based on its device type, after receiving synchronization signals and the RMSI or part of the RMSI of the anchor carrier transmitted by the serving carrier. The RMSI may contain paging monitoring configuration parameters for the UE 102 to receive paging from an anchor carrier. The UE 102 may select an anchor downlink carrier for receiving paging from a configured list of carrier frequencies based on device-type frequency priority. If paging is received in a non-anchor downlink carrier where the synchronization source is the serving carrier, the UE 102 may reselect a carrier after receiving the RMSI in the serving carrier to monitor for the paging message in the non-anchor downlink carrier. If paging is received in an anchor carrier, the UE 102 may synchronize with the anchor carrier and receive RMSI or a subset of it before receiving the paging message.

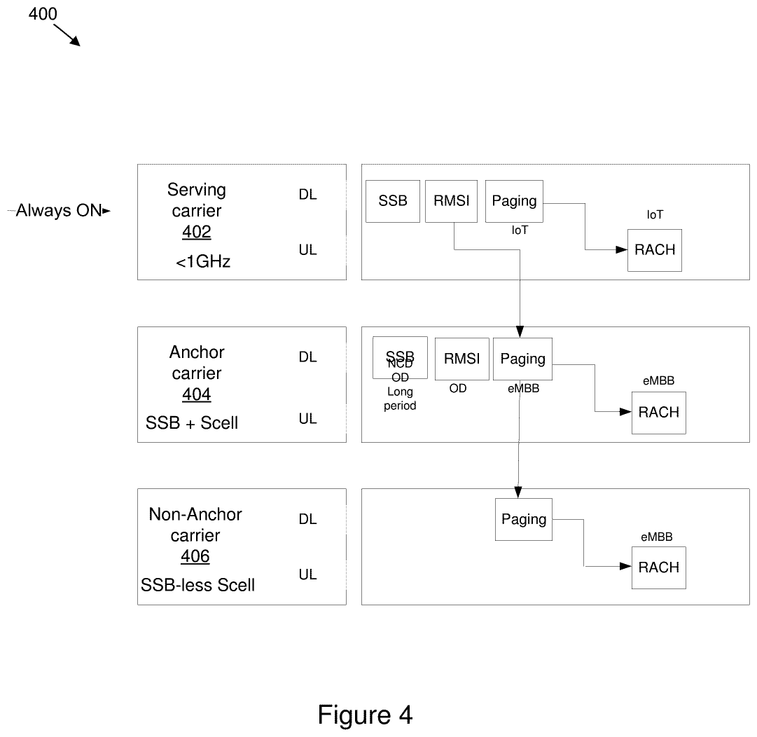

FIG. 4 illustrates an example 400 of wireless communication on multiple carriers in accordance with aspects of the present disclosure. In some examples, the wireless communication on multiple carriers may implement aspects of the wireless communications system 100. For example, one or more of an NE 102 or a UE 104 may support wireless communication on one or more of a serving carrier 402 (e.g., UL and DL, SSB and RMSI), an anchor carrier 404 (e.g., UL and DL, SSB and RMSI), or a non-anchor carrier 406 (e.g., UL and DL). Additionally, one or more of the NE 102 or the UE 104 may support random access on one or more of the serving carrier 402, the anchor carrier 404, or the non-anchor carrier 406. Additionally, or alternatively, one or more of the NE 102 or the UE 104 may support paging on one or more of the serving carrier 402, the anchor carrier 404, or the non-anchor carrier 406.

In some examples, RMSI on the serving carrier 402 may trigger paging on one or more of the serving carrier 402, the anchor carrier 404, or the non-anchor carrier 406. For example, the NE 102 may transmit, and the UE 104 may receive, the RSMI, which may indicate for paging to be performed. One or more of the NE 102 or the UE 104 may perform paging, which may include transmitting a paging message. In some examples, the paging may trigger one or more of the NE 102 or the UE 104 to perform random access (e.g., a RACH procedure).

The UE 104 may transmit an identifier indicative of a category of the UE 104. For example, the identifier may be a UE-type identifier, and the UE 104 may transmit the UE-tye identifier in a Msg3 during a random access procedure (e.g., a RACH procedure), which may be performed on the serving carrier 402 (e.g., one or more random access messages of the random access procedure transmitted and/or received on the serving carrier 402), while the NE 102 may configure a Msg4 to be transmitted on an anchor 404 or non-anchor 406 downlink carrier based on the device type. If Msg4 is received in a non-anchor 406 carrier where the synchronization source is the serving carrier, the UE 104 may reselect a carrier after transmitting Msg3 in the serving carrier to the non-anchor 406 downlink carrier for Msg4 reception. If Msg4 is received in the anchor carrier 404, the UE 104 may synchronize with the anchor carrier 404 and receive RMSI or a subset of it before receiving Msg4.

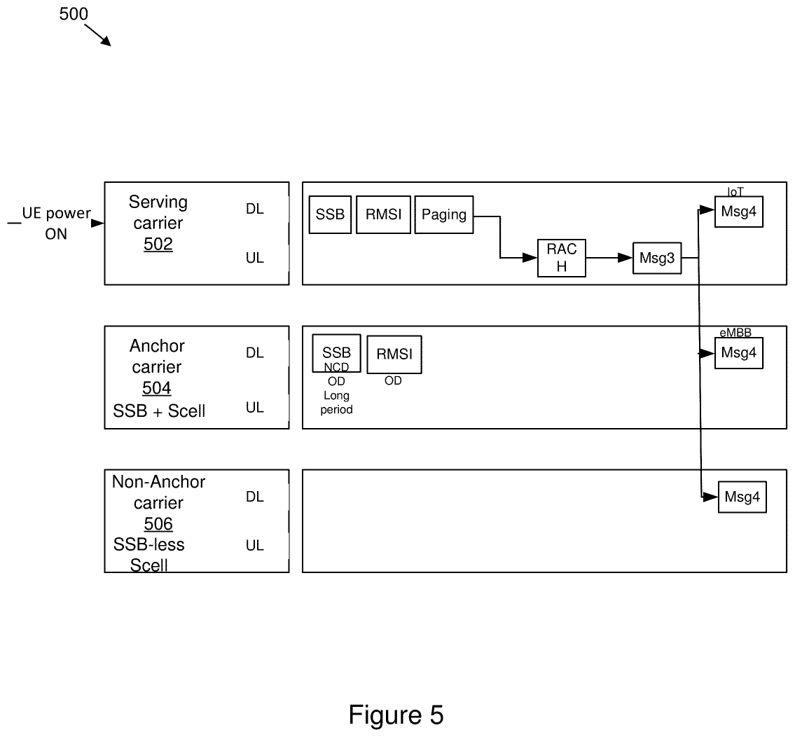

FIG. 5 illustrates an example 500 of wireless communication on multiple carriers in accordance with aspects of the present disclosure. In some examples, the wireless communication on multiple carriers may implement aspects of the wireless communications system 100. For example, one or more of an NE 102 or a UE 104 may support wireless communication on one or more of a serving carrier 502 (e.g., UL and DL, SSB and RMSI), an anchor carrier 504 (e.g., UL and DL, SSB and RMSI), or a non-anchor carrier 506 (e.g., UL and DL). Additionally, one or more of a NE 102 or a UE 104 may support random access on one or more of the serving carrier 502, the anchor carrier 504, or the non-anchor carrier 506. In some examples, a random access procedure on the serving carrier 502 may trigger transmission and reception one or more random access messages, such as one or more of transmission or reception of a Msg4 on one or more of the serving carrier 502, the anchor carrier 504, or the non-anchor carrier 506. Additionally, or alternatively, one or more of the NE 102 or the UE 104 may support paging on one or more of the serving carrier 502, the anchor carrier 504, or the non-anchor carrier 506.

The NE 102 (e.g., a base station) may configure an early paging indicator (EPI) or low-power wake-up signal (LPWUS) reception for one carrier (e.g., anchor carrier 504, non-anchor carrier 506) while configuring paging message reception for a separate carrier (e.g., anchor carrier 504, non-anchor carrier 506). A UE 102 may receive the EPI or LPWUS containing a subgroup identifier (e.g., identifier that identifiers a sub portion), which the UE 102 uses to determine a carrier for paging. The UE 102 may be configured with one of multiple subgroup identifiers based on an international mobile subscriber identity (IMSI) modulo operation (e.g., the remainder when the IMSI is divided by the number of subgroups) to allocate the subgroup identifiers across available carriers for paging. This configuration may enable efficient paging management while improving network resource allocation, coverage and power consumption. Similarly, the UE 102 may have to synchronize before receiving one or more paging messages from the anchor carrier 504 while for the non-anchor carrier 506, the synchronization source can be from the anchor carrier 504 or the serving carrier 502 before receiving the one or more paging messages. Paging parameters such as a paging cycle, etc., can be received, by the UE 102, in system information from the serving carrier 502, the anchor carrier 504, or the non-anchor carrier 506, or combination thereof.

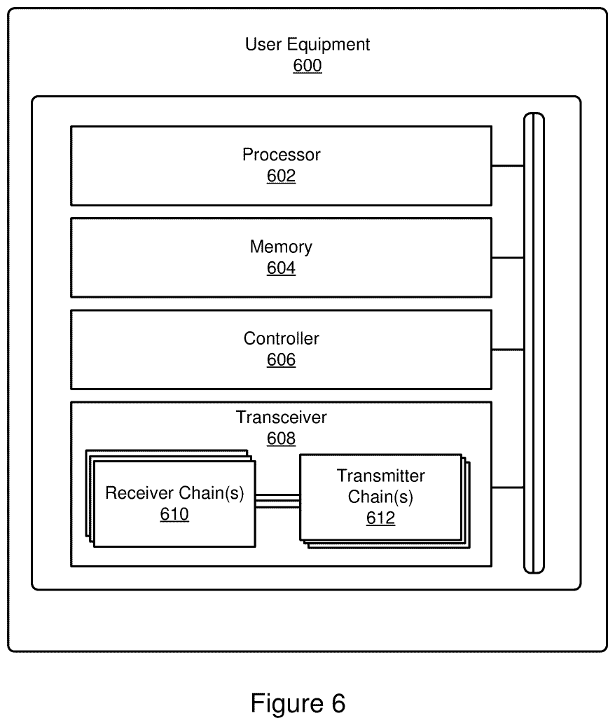

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an ASIC, or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, a field programmable gate array (FPGA), or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. For example, the processor 602 coupled with the memory 604 may be configured to cause the UE 600 to: receive, from a base station, a configuration for selecting one or more of an anchor carrier or a non-anchor carrier, wherein one or more of the anchor carrier or the non-anchor carrier is selected for at least one or more of a paging message, a RMSI, a random access procedure, or a msg4, and wherein the configuration comprises a first mapping between a set of carriers and a set of priorities associated with the set of carriers; and select the one or more of the anchor carrier or the non-anchor carrier.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like PSK or QAM. The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

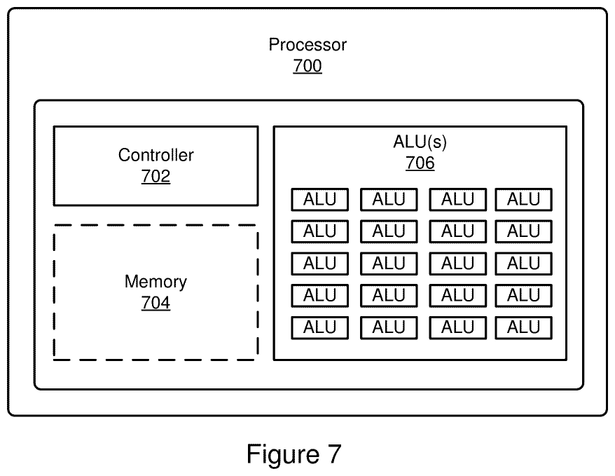

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support a means for performing various operations described herein. For example, the processor 700 may be configured to: receive, from a base station, a configuration for selecting one or more of an anchor carrier or a non-anchor carrier, wherein one or more of the anchor carrier or the non-anchor carrier is selected for at least one or more of a paging message, a RMSI, a random access procedure, or a msg4, and wherein the configuration comprises a first mapping between a set of carriers and a set of priorities associated with the set of carriers; and select the one or more of the anchor carrier or the non-anchor carrier.

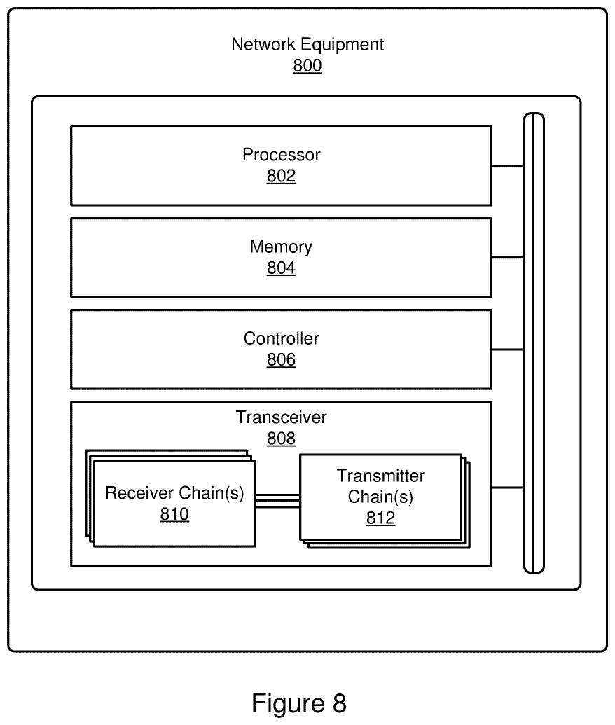

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an ASIC, or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure. For example, the processor 802 coupled with the memory 804 may be configured to cause the NE 800 to: transmit, to a UE, a configuration for selecting one or more of an anchor carrier or a non-anchor carrier, wherein one or more of the anchor carrier or the non-anchor carrier is selected for at least one or more of a paging message, a RMSI, a random access procedure, or a msg4, and wherein the configuration comprises a first mapping between a set of carriers and a set of priorities associated with the set of carriers.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

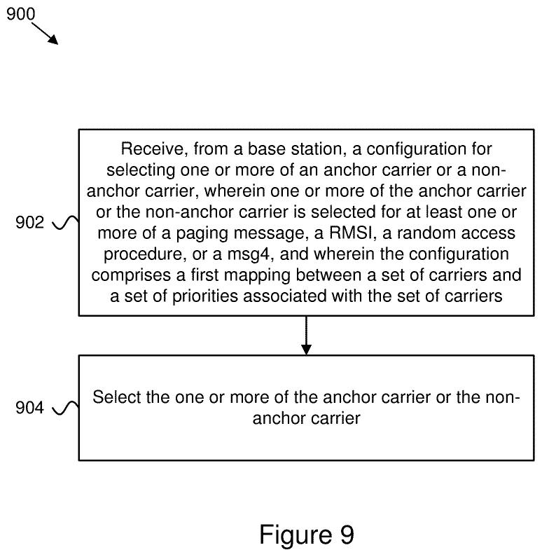

FIG. 9 illustrates a flowchart of a method 900 in accordance with aspects of the present disclosure. The operations of the method 900 may be implemented by a UE as described herein. In some implementations, the UE may execute a set of instructions to control the function elements of a processor to perform the described functions. It should be noted that the method described herein describes a possible implementation, and that the operations and the steps may be rearranged or otherwise modified and that other implementations are possible.

At 902, the method may include receiving, from a base station, a configuration for selecting one or more of an anchor carrier or a non-anchor carrier, wherein one or more of the anchor carrier or the non-anchor carrier is selected for at least one or more of a paging message, a RMSI, a random access procedure, or a msg4, and wherein the configuration comprises a first mapping between a set of carriers and a set of priorities associated with the set of carriers. The operations of 902 may be performed in accordance with examples as described herein. In some implementations, aspects of the operations of 902 may be performed by a UE as described with reference to FIG. 6.

At 904, the method may include selecting the one or more of the anchor carrier or the non-anchor carrier. The operations of 904 may be performed in accordance with examples as described herein. In some implementations, aspects of the operations of 904 may be performed by a UE as described with reference to FIG. 6.

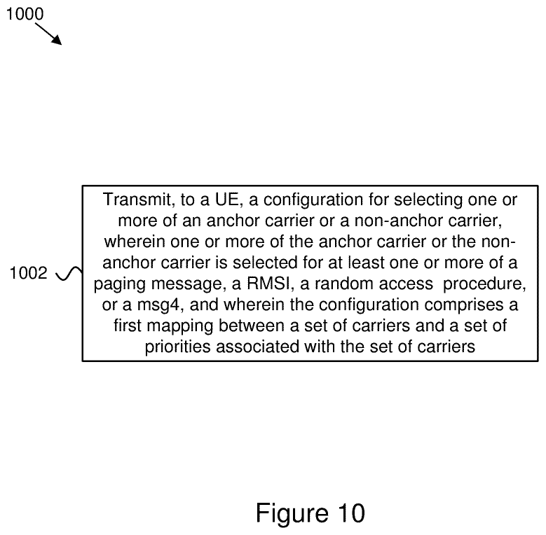

FIG. 10 illustrates a flowchart of a method 1000 in accordance with aspects of the present disclosure. The operations of the method 1000 may be implemented by a NE as described herein. In some implementations, the NE may execute a set of instructions to control the function elements of a processor to perform the described functions. It should be noted that the method described herein describes a possible implementation, and that the operations and the steps may be rearranged or otherwise modified and that other implementations are possible.

At 1002, the method may include transmitting, to a UE, a configuration for selecting one or more of an anchor carrier or a non-anchor carrier, wherein one or more of the anchor carrier or the non-anchor carrier is selected for at least one or more of a paging message, a RMSI, a random access procedure, or a msg4, and wherein the configuration comprises a first mapping between a set of carriers and a set of priorities associated with the set of carriers. The operations of 1002 may be performed in accordance with examples as described herein. In some implementations, aspects of the operations of 1002 may be performed by a NE as described with reference to FIG. 8.

It should be noted that the methods described herein describe possible implementations, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
at least one memory; and
at least one processor coupled with the at least one memory and configured to cause the UE to:
receive, from a base station, a configuration for selecting one or more of an anchor carrier or a non-anchor carrier, wherein one or more of the anchor carrier or the non-anchor carrier is selected for at least one or more of a paging message, a required minimum system information (RMSI), a random access procedure, or a random access message 4 (msg4), and wherein the configuration comprises a first mapping between a set of carriers and a set of priorities associated with the set of carriers; and
select the one or more of the anchor carrier or the non-anchor carrier.

2. The UE of claim 1, wherein one or more of:
the configuration comprises a second mapping between a set of categories of UE and a set of frequencies, wherein each category of UE of the set of categories of UE corresponds to one or more of a respective priority of the set of priorities and a respective one or more frequencies of the set of frequencies; or
the configuration comprises a third mapping between a set of classes of traffic and the set of frequencies, wherein each class of traffic corresponds to one or more of a respective priority of the set of priorities and a respective one or more frequencies of the set of frequencies.

3. The UE of claim 1, wherein one or more downlink frequencies or uplink frequencies associated with the anchor carrier or the non-anchor carrier are frequency division duplexed (FDD'ed), or wherein transmission associated with the anchor carrier or the non-anchor carrier are time division duplexed (TDD'ed).

4. The UE of claim 3, wherein one or more downlink frequencies associated with the transmission are applicable for only downlink, or wherein one or more uplink frequencies associated with the transmission are applicable for only uplink.

5. The UE of claim 1, wherein the configuration comprises a set of frequencies for the random access procedure based at least in part on receiving the paging message on a serving carrier.

6. The UE of claim 1, wherein the RMSI comprises information for paging associated with a serving carrier, the anchor carrier, or the non-anchor carrier.

7. The UE of claim 1, wherein the at least one processor is configured to cause the UE to transmit a random access message 3 (msg3) on a serving carrier, wherein the msg3 includes an identifier indicative of a category of UE.

8. The UE of claim 7, wherein the at least one processor is configured to cause the UE to receive the msg 4 on the anchor carrier or the non-anchor carrier based at least in part on the category of UE.

9. The UE of claim 1, wherein the serving carrier comprises an always-ON carrier with a cell defining downlink synchronization signal providing a physical cell identifier (ID).

10. A processor for wireless communication, comprising:
at least one controller coupled with at least one memory and configured to cause the processor to:
receive, from a base station, a configuration for selecting one or more of an anchor carrier or a non-anchor carrier, wherein one or more of the anchor carrier or the non-anchor carrier is selected for at least one or more of a paging message, a required minimum system information (RMSI), a random access procedure, or a random access message 4 (msg4), and wherein the configuration comprises a first mapping between a set of carriers and a set of priorities associated with the set of carriers; and
select the one or more of the anchor carrier or the non-anchor carrier.

11. A method performed by a user equipment (UE), the method comprising:
receiving, from a base station, a configuration for selecting one or more of an anchor carrier or a non-anchor carrier, wherein one or more of the anchor carrier or the non-anchor carrier is selected for at least one or more of a paging message, a required minimum system information (RMSI), a random access procedure, or a random access message 4 (msg4), and wherein the configuration comprises a first mapping between a set of carriers and a set of priorities associated with the set of carriers; and
selecting the one or more of the anchor carrier or the non-anchor carrier.

12. A base station, comprising:
at least one memory; and
at least one processor coupled with the at least one memory and configured to cause the base station to:
transmit, to a user equipment (UE), a configuration for selecting one or more of an anchor carrier or a non-anchor carrier, wherein one or more of the anchor carrier or the non-anchor carrier is selected for at least one or more of a paging message, a required minimum system information (RMSI), a random access procedure, or a random access message 4 (msg4), and wherein the configuration comprises a first mapping between a set of carriers and a set of priorities associated with the set of carriers.

13. The base station of claim 12, wherein one or more of:
the configuration comprises a second mapping between a set of categories of UE and a set of frequencies, wherein each category of UE of the set of categories of UE corresponds to one or more of a respective priority of the set of priorities and a respective one or more frequencies of the set of frequencies; or
the configuration comprises a third mapping between a set of classes of traffic and the set of frequencies, wherein each class of traffic corresponds to one or more of a respective priority of the set of priorities and a respective one or more frequencies of the set of frequencies.

14. The base station of claim 12, wherein one or more downlink frequencies or uplink frequencies associated with the anchor carrier or the non-anchor carrier are frequency division duplexed (FDD'ed), or wherein transmission associated with the anchor carrier or the non-anchor carrier are time division duplexed (TDD'ed).

15. The base station of claim 14, wherein one or more downlink frequencies associated with the transmission are applicable for only downlink, or wherein one or more uplink frequencies associated with the transmission are applicable for only uplink.

16. The base station of claim 12, wherein the configuration comprises a set of frequencies for the random access procedure based at least in part on receiving the paging message on a serving carrier.

17. The base station of claim 12, wherein the RMSI comprises information for paging associated with a serving carrier, the anchor carrier, or the non-anchor carrier.

18. The base station of claim 12, wherein the at least one processor is configured to cause the base station to receive a random access message 3 (msg3) on a serving carrier, wherein the msg3 includes an identifier indicative of a category of UE.

19. The base station of claim 18, wherein the at least one processor is configured to cause the base station to transmit the msg 4 on the anchor carrier or the non-anchor carrier based at least in part on the category of UE.

20. The base station of claim 18, wherein the serving carrier comprises an always-ON carrier with a cell defining downlink synchronization signal providing a physical cell identifier (ID).
